(19) United States
(12) Patent Application Publication
(10) Pub. No.: US 2024/0269582 A1
(43) Pub. Date: Aug. 15, 2024

(54) A BAFFLE FOR A SEPARATOR

(71) Applicant: Hydro International Ltd., Clevedon (GB)

(72) Inventors: Jeremy Paul LECORNU, Shepton Mallet, Somerset (GB); Philip WALSH, Bristol (GB); Daniel Stuart JARMAN, Coombe Dingle, Bristol (GB)

(73) Assignee: Hydro International Ltd., Clevedon (GB)

(21) Appl. No.: 18/568,391

(22) PCT Filed: Jun. 9, 2022
(86) PCT No.: PCT/EP2022/065771

§ 371 Date: Dec. 8, 2023

(30) Foreign Application Priority Data
Jun. 10, 2021 (GB) 2108342.3

(51) Int. Cl. B01D 21/00

(52) U.S. Cl. CPC B01D 21/0042; B01D 21/0003; B01D 21/0054; B01D 2221/12

(57) ABSTRACT

A baffle for a separator having a cylindrical chamber include a plurality of baffle components arranged in series at least part way around an axis, wherein each of the plurality of baffle components comprises a first connecting portion and a second connecting portion, wherein the first connecting portion of each of the plurality of baffle components is connectable to the first or second connecting portion of a respective first adjacent baffle component of the plurality of baffle components, wherein the second connecting portion of each of the plurality of baffle components is connectable to the first or second connecting portion of a respective second adjacent baffle component of the plurality of baffle components, wherein at least one of the baffle components comprises a vane angled with respect to the axis so as to impede the passage of fluid past the baffle in a direction parallel to the axis.

### CROSS-REFERENCE TO RELATED APPLICATIONS

This application is the U.S. national stage of PCT/EP2022/065771 filed Jun. 9, 2022, which claims priority of Great Britain Patent Application No. 2108342.3 filed on Jun. 10, 2021, the contents of which are incorporated herein.

### TECHNICAL FIELD

The invention relates to a baffle for a separator.

### BACKGROUND

Conventional gullies under roadways and other paved areas comprise a chamber having inlet and outlet pipes which open into the chamber at a position above the bottom of the chamber. There may also be a top inlet, which provides access to the interior of the chamber through a grating provided at the roadway surface, for example in a gutter. In use, solids entering the chamber, whether from the inlet pipe or through the grating, collect under gravity in the base of the chamber and can be extracted at intervals by means of a suction pipe introduced into the chamber after removing the grating. Such gullies have a low separation efficiency. Furthermore, in the event of heavy storm flows, collected solids in the base of the chamber, and solids floating on the surface tend to be stirred up, and can pass into the outlet pipe.

A hydrodynamic vortex separator may be used to improve the separation efficiency of the gully. Such separators create a circulating flow within the chamber which assists in causing any solids within the incoming flow to accumulate and fall to the bottom of the chamber or rise to the fluid surface depending upon their density. In known arrangements, a frustoconical base is provided within the chamber that has an opening into a sump. The frustoconical base allows sediment to be collected in the sump but prevents resuspension of particles during high-flow rates by limiting advective low currents from entering the sump. However, such frustoconical bases may be difficult to install in a manner that ensures their effective operation.

It is therefore desirable to provide a baffle for a separator that addresses this issue.

### SUMMARY

According to a first aspect there is described a baffle for a separator having a cylindrical chamber, the baffle comprising a plurality of baffle components arranged in series at least part way around an axis. Each of the plurality of baffle components comprises a first connecting portion and a second connecting portion. The first connecting portion of each of the plurality of baffle components is connectable to the first or second connecting portion of a respective first adjacent baffle component of the plurality of baffle components. The second connecting portion of each of the plurality of baffle components is connectable to the first or second connecting portion of a respective second adjacent baffle component of the plurality of baffle components. At least one of the baffle components comprises a vane angled with respect to the axis so as to impede the passage of fluid past the baffle.

The plurality of baffle components may be connected in series in a continuous loop that extends around the axis.

Each of the plurality of baffle components may comprise a first flange defining the first connecting portion and a second flange defining the second connecting portion.

The first flange may be connected to the vane by a first support structure. The second flange may be connected to the vane by a second support structure. The first flange may be recessed with respect to the first support structure. The second flange may extend beyond the second support structure in a direction perpendicular to the angle of the vane.

At least a portion of the profile of an edge of the first flange may correspond to at least a portion of the profile of an edge of the second flange.

The first and second flanges may be offset from each other in a dimension perpendicular to the axis.

The first and second flanges may curve toward the vane in a distal direction.

The first connecting portion and the second connecting portion of two or more of the plurality of baffle components may be configured to allow the extent to which the two or more of plurality of baffle components overlap each other to be adjusted during installation of the baffle within the cylindrical chamber.

One of the first or second connecting portions of at least one of the plurality of baffle components may comprise a hole for connecting the baffle component to a first adjacent baffle component and the other of the first or second connecting portions of the baffle component may comprise a slot for connecting the baffle component to a second adjacent baffle component. The slot may be oriented toward the hole.

Each of the plurality of baffle components may comprise a respective vane angled with respect to the axis so as to impede the passage of fluid past the baffle.

The vane of each of the plurality of baffle components may comprise a leading edge surface. The leading edge surfaces of each of the vanes may be coplanar and form part of an interrupted annular surface extending perpendicularly to the axis.

Each of the vanes may define a channel extending through the respective baffle component.

The vane of each of the baffle components may be disposed between the first and second connecting portions of the respective baffle component.

One or more of the baffle components may comprise a plurality of vanes separated by one or more gaps.

Each vane may define a recess having an interior profile corresponding to an exterior profile of the vane.

The vanes may overlap in a circumferential direction of the baffle such that they extend circumferentially around the entirety of the baffle.

The vanes may be cantilevered.

The vanes may be supported at their radially outer end.

The baffle components may be substantially identical.

The baffle components may be formed by a molding process.

There may be provided a baffle component as described in any preceding statement.

There may be provided a separator as described in any preceding statement. The cylindrical chamber may comprise an upper region and a lower region. The upper region may comprise an inlet module configured to deliver flow into the cylindrical chamber in a rotational direction about the axis. The baffle may be disposed between the upper region and the lower region and impede the passage of fluid past the baffle from the upper region to the lower region. The vanes may be angled toward the upper region in the rotational direction.

According to a second aspect there is described a method for assembling a baffle as claimed in any preceding claim, the method comprising: positioning the plurality of baffle components within the cylindrical chamber; and connecting the first connecting portion of each of the plurality of baffle components to the second connecting portion of a respective adjacent baffle component of the plurality of baffle components and to the cylindrical chamber.

### BRIEF DESCRIPTION OF DRAWINGS

For a better understanding of the present invention, and to show more clearly how it may be carried into effect, reference will now be made, by way of example, to the accompanying drawings, in which:

FIG. 1 is a cutaway perspective view of a separator;

FIG. 2 is a cutaway perspective view of a baffle within a chamber of the separator;

FIG. 3 is a perspective view of a baffle component of the baffle;

FIG. 4 is a cross-sectional view of the baffle component;

FIG. 5 is a front view of the baffle component;

FIG. 6 is a back view of the baffle component;

FIG. 7 is a cutaway perspective view of the baffle part way through installation;

FIG. 8 is a flow chart showing the method for assembling the baffle;

FIG. 9 is a cross-sectional view of the separator;

FIG. 10 is a perspective view of a plurality of baffle components in a stacked configuration;

FIG. 11 is a cutaway perspective view of a first alternative baffle component within the chamber of the separator;

FIG. 12 is a perspective view of a second alternative baffle component;

FIG. 13 is a cross-sectional view of the second alternative baffle component;

FIG. 14 is a cutaway perspective view of a baffle comprising a plurality of the second alternative baffle components part way through installation;

FIG. 15 is a perspective view of a third alternative baffle component;

FIG. 16 is a cutaway perspective view of a baffle comprising a plurality of the third alternative baffle components part way through installation; and

FIG. 17 is a cutaway perspective view of a fourth alternative baffle component within the chamber of the separator.

### DETAILED DESCRIPTION OF PREFERRED EMBODIMENTS

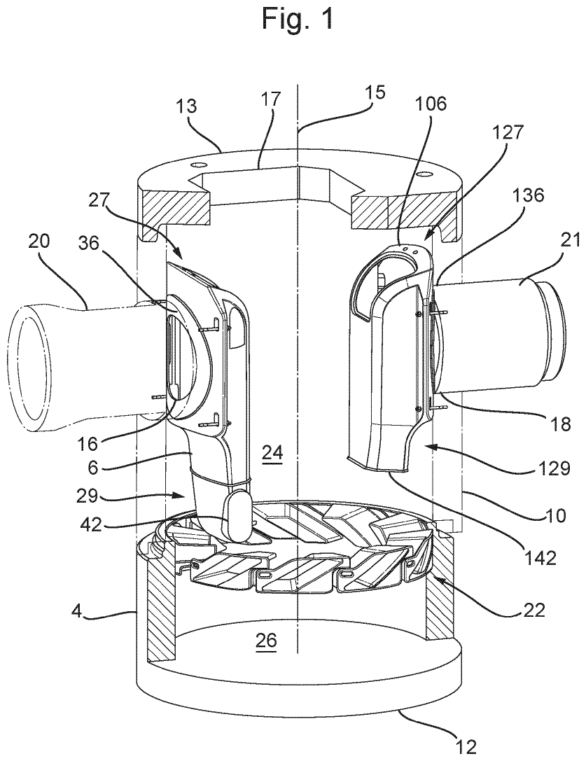

FIG. 1 is a cutaway perspective view of a separator 2 comprising a chamber 4, a baffle or benching skirt 22, an inlet module 6 and an outlet module 106. The chamber 4 is shown as being semi-transparent in FIG. 1 in order to show the internal features of the separator 2. The chamber 4 comprises a side wall or chamber wall 10 and a lower wall 12. The chamber 4 and chamber wall 10 are cylindrical and extend around a central axis 15. The baffle 22 is positioned within the chamber 4. The chamber wall 10 has an inlet opening 16 and an outlet opening 18. An inlet conduit 20 is connected to the inlet opening 16 and an outlet conduit 21 is connected to the outlet opening 18. The lower wall 12 closes off the lower end of the chamber 4. The chamber 4 additionally comprises an upper wall 13 that closes off the upper end of the chamber 4. The upper wall may comprise a manhole 17 for accessing an interior of the chamber 4. The inlet module 6 and the outlet module 106 are disposed in the chamber 4, adjacent the inlet opening 16 and outlet opening 18, respectively. The chamber 4 comprises an upper region 24 and a lower region 26. The inlet module 6 and outlet module 106 are disposed within the upper region 24. The baffle 22 is disposed between the upper region 24 and the lower region 26. The lower region 26 forms a sump for collecting grit at the base of the chamber 4.

The inlet module 6 comprises an attachment portion 27 and a projecting portion 29. The attachment portion 27 attaches to and seals against the chamber wall 10. The projecting portion 29 projects (i.e. extends or protrudes) from the attachment portion 27. The inlet module 6 defines an inlet 36 and an outlet 42. The attachment portion 27 defines the inlet 36 and a distal end or lower portion of the attachment portion 27 defines the outlet 42. The attachment portion 27 and the projecting portion 29 define a fluid passageway fluidically connecting the inlet 36 to the outlet 42. The outlet 42 is directed tangentially with respect to the central axis 15 of the chamber 4.

The geometry of the outlet module 106 substantially corresponds to the geometry of the inlet module 6. Corresponding features of the outlet module 106 are denoted using corresponding reference numerals as the features of the inlet module 6, with the addition of a value of 100. The geometry of the outlet module 106 differs from the geometry of the inlet module 6 in that the distal end of the projecting portion 129 of the outlet module 106 terminates closer to the attachment portion 127 than the projecting portion 29 of the inlet module 6. In addition, the features defining the inlet 36 of the inlet module 6 instead define the outlet of the outlet module 106. Further, the inlet 142 is directed parallel to the central axis 15 of the chamber 4 rather than tangentially with respect to the central axis 15.

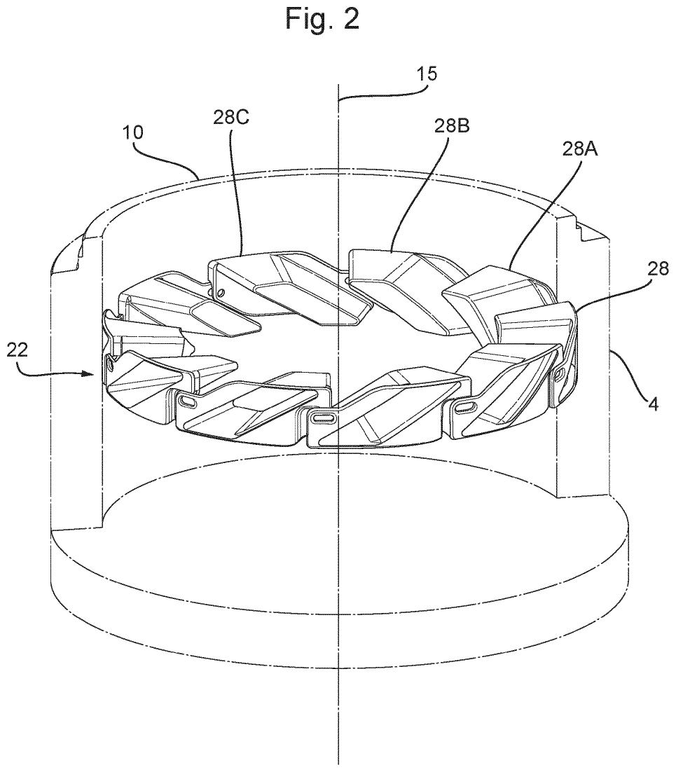

FIG. 2 is a cutaway perspective view of the baffle 22 within the chamber 4 of the separator 2. The baffle 22 comprises a plurality of baffle components 28. In the arrangement shown in FIG. 2, the baffle 22 comprises a total of ten baffle components 28. However, the baffle 22 may comprise any suitable number of baffle components 28. A first baffle component 28A of the plurality of baffle components 28, a second baffle component 28B of the plurality of baffle components 28 and a third baffle component 28C of the plurality of baffle components 28 are referenced in FIG. 2. Each of the baffle components 28 are identical or substantially the same as each other.

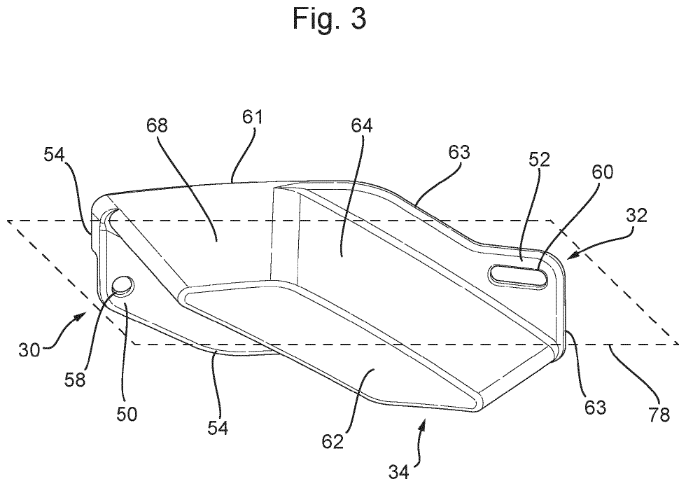

FIG. 3 is a perspective view of a baffle component 28 in isolation. The baffle component 28 generally comprises a first connecting portion 30, a second connecting portion 32 and a vane or blade 34. The first connecting portion 30 comprises a hole 58. The second connecting portion 32 comprises a slot 60. A first flange 50 of the baffle component 28 defines the first connecting portion 30, and, thus, the hole 58. The first flange 50 is connected to the vane 34 by a first support structure 54 in the form of a flange. A second flange 52 of the baffle component 28 defines the second connecting portion 32, and, thus, the slot 60. The second flange 52 is connected to the vane 34 by a second support structure 63 in the form of a flange. The slot 60 is oriented toward the hole 58 (i.e. the maximum dimension of the slot 60 extends toward the hole 58).

The vane 34 is disposed between the connecting portions 30, 32 and extends between a proximal end 61 adjacent the first and second connecting portions 30, 32 and a distal end away from the first and second connecting portions 30, 32. The distal end of the vane 34 is defined by a distal wall 62. The vane 34 further comprises a first wall 64, a second wall 66 (not shown in FIG. 3) opposing the first wall 64, a third wall 68 and a fourth wall 70 (not shown in FIG. 3) opposing the third wall 68. The first, second, third and fourth walls 64, 66, 68, 70 extend between the proximal end 61 of the vane 34 and the distal wall 62. The first and second walls 64, 66 are connected together at opposing ends by the third and fourth walls 68, 70. The first and second flanges 50, 52, the first and second connecting portions 54, 63, the distal wall 62 and the first, second, third and fourth walls 64, 66, 68, 70 are unitary. The vane 34 spans the entire length of the baffle component 28. By providing a vane 34 in which the first and second walls 64, 66 are spaced apart and connected by third, fourth and distal walls 68, 70, 62, the thickness of the vane 34 is increased, and, thus, the robustness of the vane 34 is improved due to it having a larger second moment of area.

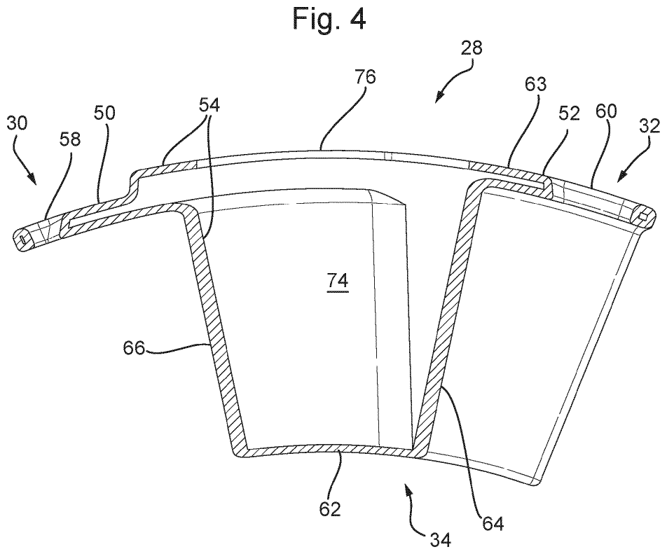

FIG. 4 is a cross-sectional view of the baffle component 28, taken along a plane 78 (shown in FIG. 3) on which the hole 58 and slot 60 lie. The first and second flanges 50, 52 and the first and second support structures 54, 63 are curved surfaces that curve toward the vane 34 in a distal direction. The first and second flanges 50, 52 and the first and second support structures 54, 63 form part of cylindrical surfaces that extend part way around a common axis, which may correspond to the central axis 15. The second flange 52 and the first and second support structures 54, 63 form part of a single cylindrical surface that extends part way around the central axis 15. The first flange 50 is spaced from the common axis by a first distance (i.e. a first radius) and the second flange 52 and first and second support structures 54, 63 are spaced from the common axis by a second distance (i.e. a second radius) greater than the first distance. Accordingly, the first flange 50 is concentric with the second flange 52 and first and second support structures 54, 63, and the second flange 52 and the first and second support structures 54, 63 are offset from the first flange 50 in an outward direction. In alternative arrangements, the abovementioned direction of offset may be reversed.

The vane 34 defines a recess 74. An opening 76 to the recess 74 is provided at the proximal end 61 of the vane 34. The baffle component 28 is formed of plastic using a molding process. In particular, the baffle component 28 shown in FIG. 4 is formed in part by a rotational molding process. The rotational molding process produces a precursor baffle component substantially corresponding to the baffle component 28. However, the precursor baffle component comprises a continuous surface between the first and second connecting portions 30, 32 rather than the opening 76. Accordingly, the precursor baffle component has a hollow, completely enclosed interior.

To manufacture the baffle component 28 from the precursor baffle component, the opening 76 is cut out of the precursor baffle component. Consequently, the vane 34 has a single wall thickness and the first and second flanges and support structures 50, 52, 54, 63 have a double wall thickness. The first and second flanges and support structures 50, 52, 54, 63 having a double wall thickness rather than a single wall thickness may increase their strength and rigidity, and, thus, the strength and rigidity of the baffle component 28. The vane 34 having a single wall thickness rather than a double wall thickness may avoid unnecessary weight.

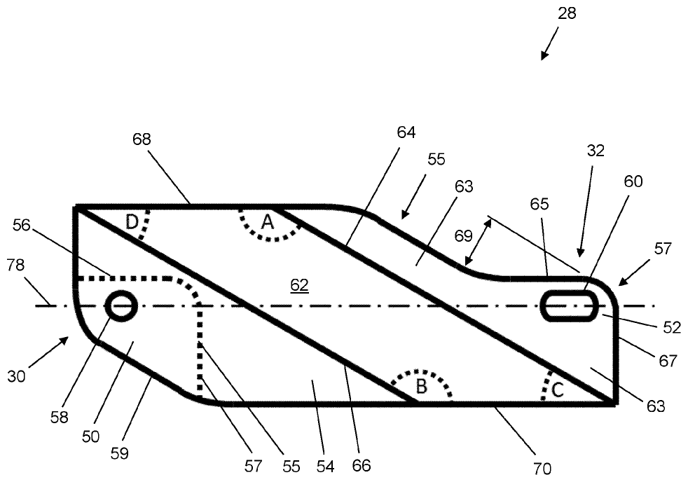

FIG. 5 is a front view of the baffle component 28. The first support structure 54 extends along the length of the fourth wall 66 of the vane 34. The first flange 50 is recessed with respect to the first support structure 54. A step 55 is thus formed between the first flange 50 and the first support structure 54. The step 55 is located on the side of the baffle component 28 facing away from the viewpoint of FIG. 5 and is represented in phantom in FIG. 5. A first edge 56 of the first flange 50 extends parallel to the plane 78, a second edge 57 of the first flange 50 extends perpendicular to the plane 78 and a third edge 59 of the first flange 50 extends substantially parallel to the fourth wall 66 of the vane 34. The first flange 50 is therefore substantially triangular in shape. The first support structure 54 strengthens and provides rigidity to the first flange 50 and the vane 34 and increases the surface area of the baffle component 28 in contact with the chamber wall 10.

The second support structure 63 extends along the length of the first wall 64 of the vane 34. The second flange 52 is not recessed with respect to the second support structure 63, and the second flange 52 instead forms a continuation of the second support structure 63. A first edge 65 of the second flange 52 extends parallel to the plane 78 and a second edge 67 of the second flange 52 extends perpendicular to the plane 78. The second flange 52 is therefore substantially triangular in shape. The first edge 65 of the second flange 52 is aligned with the first edge 56 of the first flange 50. The profile of the second flange 52 defined by the first and second edges 65, 67 substantially corresponds to the profile of the first flange 50 defined by the first and second edges 56, 57. The second flange 52 extends beyond the second support structure 63 in a direction 69 perpendicular to the angle of the vane 34 (i.e. the angle of the first and fourth walls 64, 66 of the vane 34). The second support structure 63 strengthens and provides rigidity to the second flange 52 and the vane 34 and increases the surface area of the baffle component 28 in contact with the chamber wall 10.

As shown, an obtuse angle A is formed between the first and third walls 64, 68, an obtuse angle B is formed between the second and fourth walls 66, 70, an acute angle C is formed between the first and fourth walls 64, 70 and an acute angle D is formed between the second and third walls 66, 68. Angles A and B are equal and angles C and D are equal. Angles A and B may be 150 degrees, for example. Angles C and D may be 30 degrees, for example. The third and fourth walls 68, 70 extend parallel to the plane 78 on which the hole 58 and slot 60 lie. In the examples shown in FIGS. 1 to 5, the vane 34 has a right-handed chirality. That is, when the vane 34 is observed from its distal end with the plane 78 extending horizontally, the vane 34 descends in a right-hand direction.

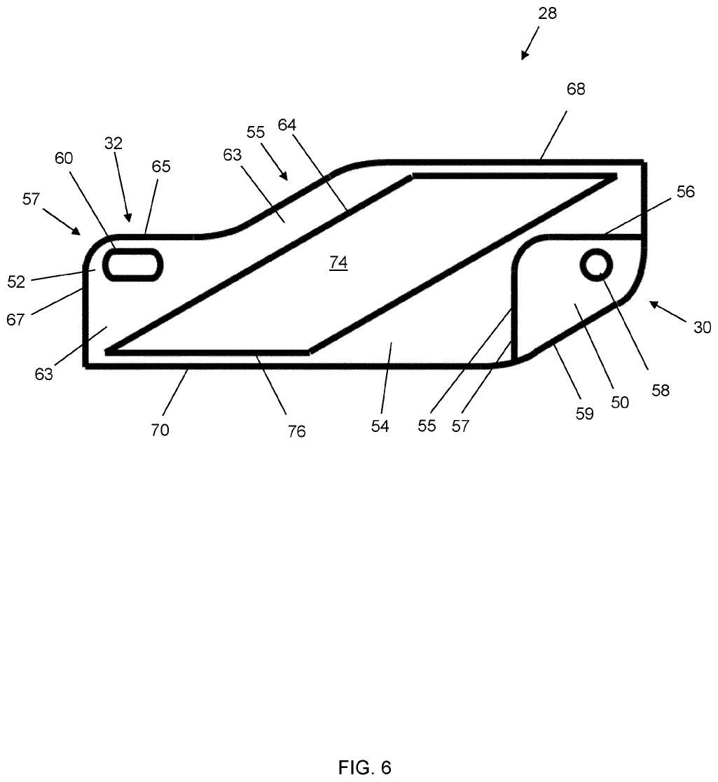

FIG. 6 is a back view of the baffle component 28 showing the recess 74 of the vane 34 and the recess formed by the first flange 50.

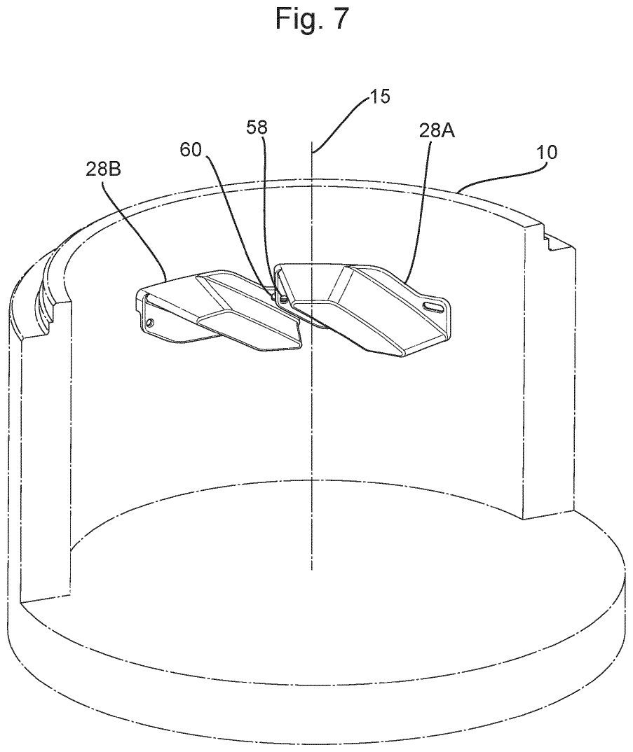

FIG. 7 is a cutaway perspective view showing the baffle 22 part way through installation. To form a baffle 22 from a plurality of baffle components 28, a first baffle component 28A of the plurality of baffle components 28 and a second component 28B of the plurality of baffle components 28 are connected. In the example shown in FIG. 7, the first connecting portion 30 of the first baffle component 28A is connected to the second connecting portion 32 of the second component 28B. The second flange 52 of the second component 28B is inserted into the recess formed by the first flange 50 and first support structure 54 of the first component 28A such that the first flange 50 of the first baffle component 28A abuts the second flange 52 of the second component 28B. The corresponding profiles of the first and second edges 504, 506, 512, 514 of the first and second flanges 50, 52 can be used to locate the first and second components 28A, 28B in the correct relative orientations. The hole 58 of the first baffle component 28A is aligned with the slot 60 of the second baffle component 28B. By altering the position of the hole 58 along the slot 60, the extent to which the first and second baffle components 28A, 28B overlap can be adjusted to account for variations in the internal diameter of the chamber 10. A fastener (not shown) such as a screw is placed through the hole 58 and slot 60 and secured into the chamber wall 10. In this manner, the first and second baffle components 28A, 28B are connected together and to the chamber wall 10. The extent by which the first and second flanges 50, 52 are offset from each other in an outward direction is such that the profile of the outer surface of the first flange 50 corresponds to the profile of the inner surface of the second flange 52 of the neighbouring baffle component 28. Since the first and second flanges 50, 52 are offset from each other (i.e. stepped), they are spliced together so as to form half lap splice joints.

This process is repeated until the plurality of baffle components 28 are arranged annularly around the axis 15 and connected in series to each other in a continuous loop so as to form a complete baffle 22. That is, each of the plurality of baffle components 28 is connected to two adjacent baffle components 28 of the plurality of baffle components 28 so as to form an unbroken series or chain of connected baffle components 28. The vanes 34 extend radially toward the axis 15 but terminate before meeting the axis 15. The baffle components 28 are distinct (i.e. discrete/separate) components. However, they form a single baffle 22 when connected. The connections may be releasable, and, thus, temporary.

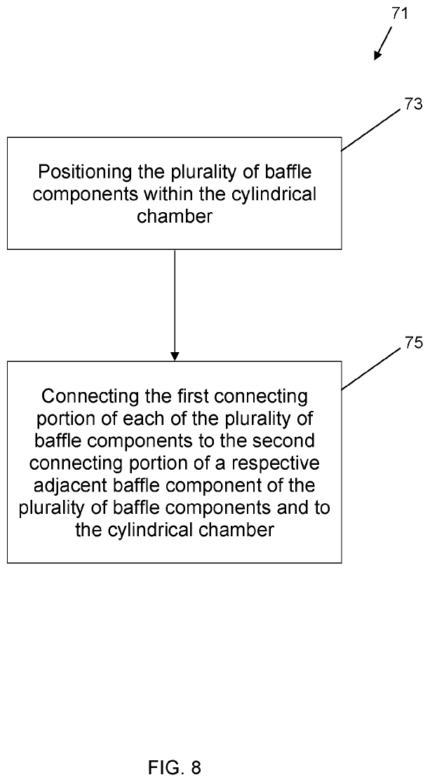

FIG. 8 is a flow chart showing the method 71 for assembling the baffle 22. The method comprises a first step 73 and a second step 75. The first step 73 comprises positioning the plurality of baffle components 28 within the cylindrical chamber 4. The second step 75 comprises connecting the first connecting portion 30 of each of the baffle components 28 to the second connecting portion 32 of a respective adjacent baffle component 28 of the plurality of baffle components 28 and to the cylindrical chamber 4.

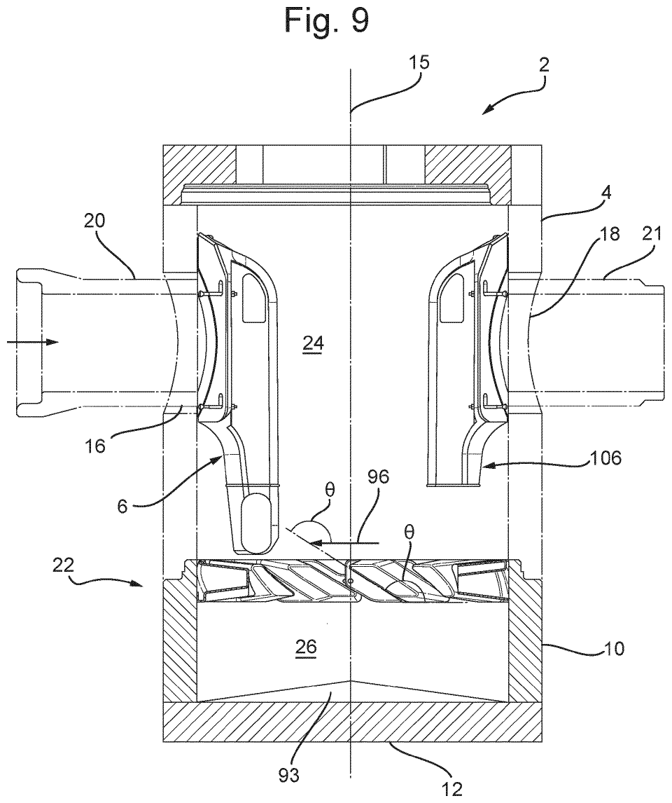

FIG. 9 is a cross-sectional side view of the separator 2, in use.

During operation, fluid in the form of water flows through the inlet conduit 20, through the inlet opening 16 of the chamber wall 10, through the inlet 36 of the inlet module 6 and into the passageway defined by the walls of the inlet module 6. The fluid passes along the passageway and out of the inlet module 6 via the outlet 42 (not shown in FIG. 9). The outlet 42 is directed tangentially with respect to the central axis 15. Accordingly, the fluid exits the inlet module 6 in a tangential direction with respect to the central axis 15 such that a circulating flow or vortex flow is stablished within the chamber 4. This relatively low-energy circulating flow assists in causing any solids within the incoming flow to either accumulate and move in the direction of the bottom of the chamber 4 or rise to the fluid surface depending upon their density. In this manner, the separator 2 acts as a hydrodynamic vortex separator.

In the arrangement described with reference to FIGS. 1 to 9, the fluid exits the inlet module 6 such that the angular velocity of the flow of water in the upper region 24 of the chamber 4 is oriented away from the lower region 26 of the chamber and toward the upper region 24 of the chamber 4. That is, the fluid circulates in the upper region 24 of the chamber 4 about the central axis 15 in an anti-clockwise direction when viewed from above and in a clockwise direction when viewed from below. The direction of the flow of fluid within the portion of the chamber 4 shown in the cross-sectional view of FIG. 9 is represented by arrow 96.

The vanes 34 of the baffle components 28 circumferentially overlap. That is, when viewed in the axial direction (i.e. from a position along axis 15) the vanes 34 approximate a continuous annular surface. The first and second flanges 50, 52 and the first and second support structures 54, 63 extend in a circumferential direction of the baffle 22. The third walls 68 of the baffle components 28 are coplanar and form part of an interrupted annular surface that extends perpendicularly to the central axis 15. The first and second connecting portions 30, 32, the first and second support structures 54, 63 and the proximal ends 61 of the plurality of vanes 34 form a continuous annular body disposed adjacent the chamber wall 10, between the chamber wall 10 and the vanes 34. The vanes 34 are cantilevered and only supported at their radially outer (i.e. proximal) ends 61. Accordingly, the vanes 34 are not supported at their distal ends.

As the fluid 96 rotates within the upper region 24 of the chamber 4, it is exposed to vanes 34 that are angled upwards in a downstream direction (i.e. they are angled towards the upper region 24 in a downstream direction). An obtuse angle θ is formed between the vanes 34 and the plane of the baffle 22, and, thus, the direction of fluid flow 96. Accordingly, the circulating flow within the upper region 24 is deflected away from the lower region 26 by the angle of the vanes 34 and the vanes 34 impede (i.e. reduce or limit) the passage of fluid from the upper region 24 to the lower region 26. Solids (e.g. sediment) are still able to pass from the upper region 24 to the lower region 26, either past the vanes 34 or through the central region of the baffle 22, where they collect 93 on the lower wall 12.

By impeding the flow of fluid 96 past the baffle 22, advective flow within the lower region 26 of the chamber 4 is reduced, and, thus, resuspension of solid particles during operation of the separator 2 (e.g. during periods of high-flow rate into the separator 2) is reduced. In particular, by impeding the flow of fluid 96 past the baffle 22, advective mixing, turbulence and drag and lift forces due to shear stress on solids or the chamber wall 10 are reduced and quiescent behavior of fluid within the lower region 26 is increased, thereby reducing washout.

The fluid in the chamber 4 enters the outlet module 106 via the inlet 142, passes along the passageway defined by the walls of the outlet module 106, exits the outlet module 106 via the outlet 136, passes out of the chamber 4 via the outlet opening 18 of the chamber wall 10 and flows away from the chamber 4 via the outlet conduit 21.

The manner in which the first and second connecting portions 30 of adjacent discrete baffle components 28 are connected in order to form a baffle 22 allows the spacing between the baffle components 28 to be varied to account for variations in manufacturing tolerances of the chamber 10 (i.e. differences in the internal diameter of the chamber 10). For example, the baffle components 28 may be assembled such that the outer diameter of the baffle 22 (i.e. the diameter of the perimeter of the baffle) corresponds to the inner diameter of the chamber wall 10. This modular configuration minimises or eliminates any gap that would otherwise form between the baffle 22 and the chamber wall 10 if the internal diameter of the chamber wall 10 is larger than nominal. Such gaps allow flow to enter the lower region 26 of the chamber 4, which can resuspend solids that have previously been captured in the lower region 26 and reduce the efficiency of the baffle 22 and the separator 2 as a whole. This also avoids any distortion of the baffle 22 that would otherwise result from being installed within a chamber wall 10 having an internal diameter that is smaller than nominal, which also avoids a reduction in performance and service life of the baffle 22. By forming the baffle 22 from multiple discrete baffle components 28, the strength, robustness and rigidity of the baffle 22 as a whole is improved, and, the baffle 22 is easier to store and transport in disassembled form.

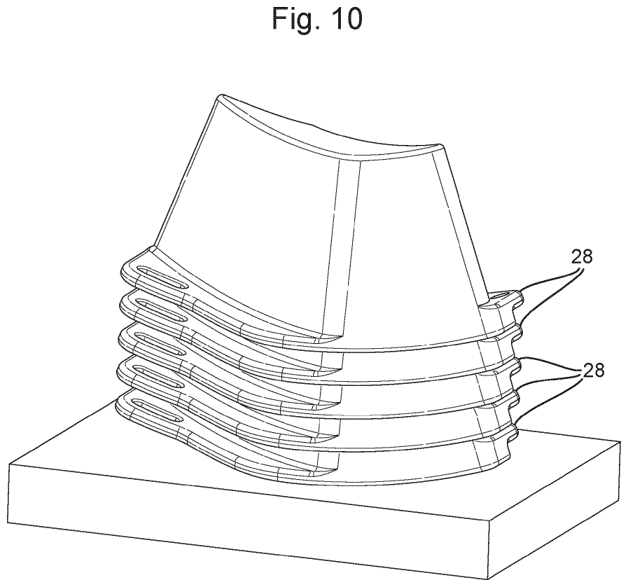

FIG. 10 is a perspective view of a plurality of baffle components 28 in a stacked configuration. As mentioned previously, the vanes 34 of the baffle components 28 define recesses 74. The shape of the interior of the recess 74 corresponds to the shape of the exterior of the vane 34 such that the recesses 74 of the baffle components 28 are configured to receive the vanes 34 of other baffle components 28, and vice versa. This improves the ease and cost of transportability and storage of the baffle components 28.

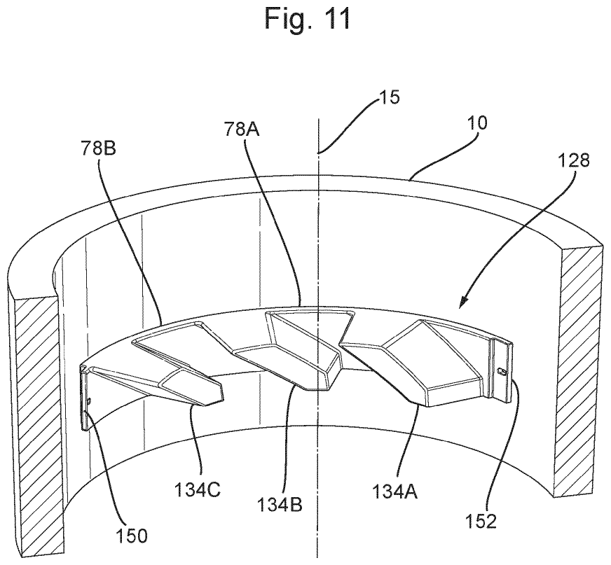

FIG. 11 is a cutaway perspective view of a first alternative baffle component 128 within a chamber of the separator. The first alternative baffle component 128 substantially corresponds to the baffle component 28 described with reference to FIGS. 1 to 9 and may be assembled into a baffle in a corresponding manner as that described previously. Corresponding features of the first alternative baffle component 128 are denoted using corresponding reference numerals as the features of the baffle component 28, with the addition of a value of 100. The first alternative baffle component 128 differs from the baffle component 28 in that it comprises multiple vanes 134A, 134B, 134C rather than a single vane. The vanes 134A, 134B, 134C of the first alternative baffle component 128 substantially correspond to the vanes 34 of the baffle components 28 described with reference to FIGS. 1 to 10. In the arrangement shown in FIG. 11, the first alternative baffle component 128 comprises a first vane 134A, a second vane 134B and a second vane 134C, however the first alternative baffle component 128 may comprise any multiplicity of vanes 134.

The first alternative baffle component 128 additionally comprises a first connecting flange 78A and a second connecting flange 78B. The first connecting flange 78A connects the first and second vanes 134A, 134B and spaces them apart from each other. The second connecting flange 78B connects the second and third vanes 134B, 134C and spaces them apart from each other. The first and second flanges 150, 152, first, second and third vanes 134A, 134B, 134C and first and second connecting flanges 78A, 78B are unitary and together form a backing strip. The first alternative baffle component 128 is formed of plastic and manufactured by a rotational molding process. The first connecting flange 78A, the second connecting flange 78B and the first and second flanges 150, 152 form part of respective cylindrical surfaces that extend part way around the axis 15.

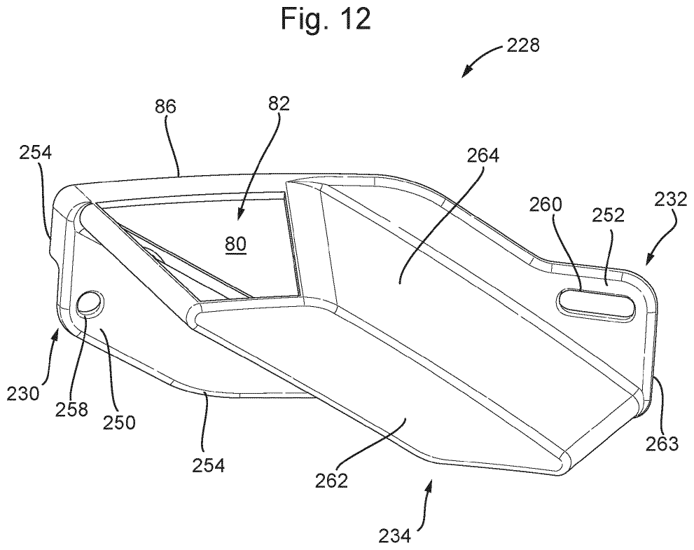

FIG. 12 is a perspective view of a second alternative baffle component 228. The second alternative baffle component 228 substantially corresponds to the baffle component 28 described with reference to FIGS. 1 to 10. Corresponding features of the second alternative baffle component 228 are denoted using corresponding reference numerals as the features of the baffle component 28, with the addition of a value of 200. The second alternative baffle component 228 differs from the baffle component 28 in that the vane 234 of the second alternative baffle component 228 does not include third and fourth walls 68 and 70. Instead, a through hole or channel 80 extends through the vane 234 and runs parallel to the first and second walls 264, 266 and the distal wall 262 between an inlet 82 and an outlet 84 (not shown in FIG. 12). The distal wall 262 connects the first and second walls 264, 266. A first brace 86 connects the first and second walls 264, 266 at a first end of the second alternative baffle component 228 and a second brace 88 (not shown in FIG. 12) connects the first and second walls 264, 266 at a second end of the second alternative baffle component 228

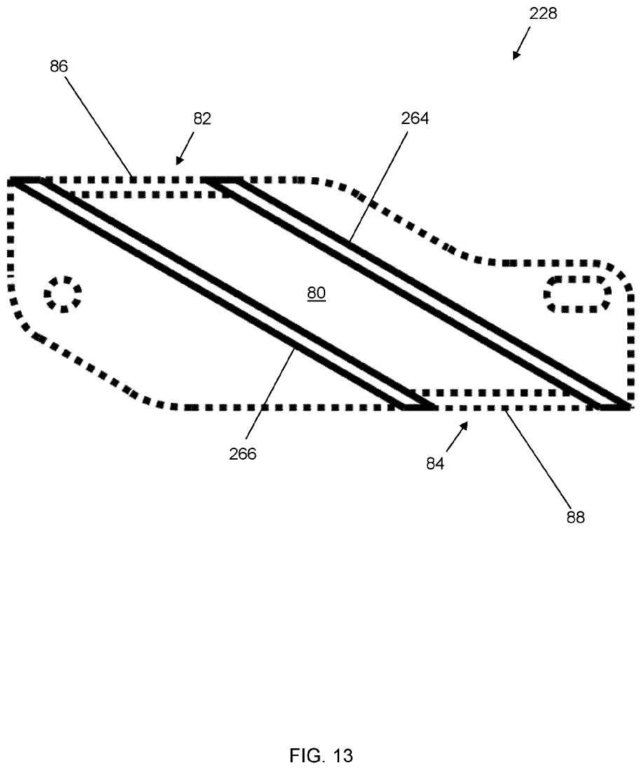

FIG. 13 is a cross-sectional view of the second alternative baffle component 228 showing the through hole or channel 80 extending through the vane 234 and running parallel to the first and second walls 264, 266 between the inlet 82 and the outlet 84. Features beyond the plane of the cross-section are shown in phantom.

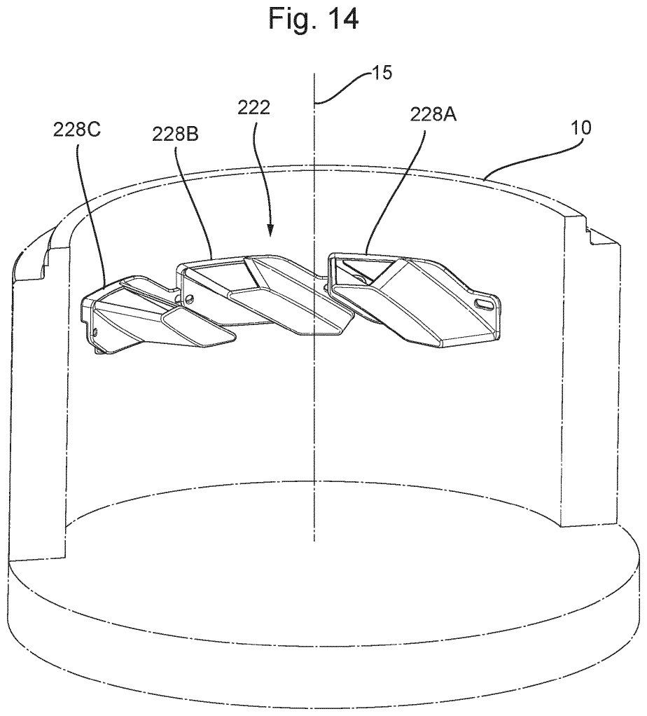

FIG. 14 is a cutaway perspective view of a baffle 222 comprising three of the second alternative baffle components 228A, 228B, 228C part way through installation. The installation process is the same as that described previously. During operation, solids are able to pass from the upper region 24 to the lower region 26 through the gaps between adjacent vanes 234 and additionally through the through holes 80, from the inlet 82 to the outlet 84.

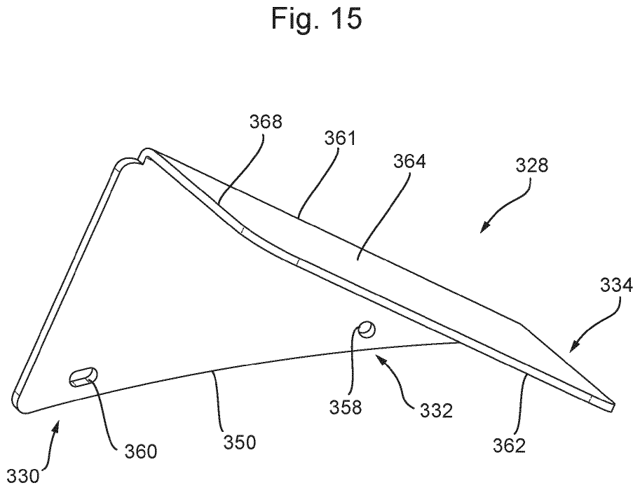

FIG. 15 is a perspective view of a third alternative baffle component 328. The third alternative baffle component 328 substantially corresponds to the baffle component 28 described with reference to FIGS. 1 to 10. Corresponding features of the third alternative baffle component 328 are denoted using corresponding reference numerals as the features of the baffle component 28, with the addition of a value of 300. The third alternative baffle component 328 comprises an L-shaped bracket and generally comprises a first connecting portion 330, a second connecting portion 332 and a vane 334. A first flange 350 of the third alternative baffle component 328 defines both the first connecting portion 330 and the second connecting portion 332. The first connecting portion 330 of the first flange 350 comprises a slot 360. The second connecting portion 332 of the first flange 350 comprises a hole 358. The slot 360 is oriented toward the hole 358 (i.e. has its maximum dimension in a direction extending toward the hole 358).

A second flange 334 of the third alternative baffle component 328 extends perpendicularly from the first flange 350 and defines a vane. The vane 334 extends between a proximal end 361 adjacent the first flange 350 and a distal end 362 away from the first flange 350. The vane 34 is disposed on a single side of the connecting portions 330, 332 (i.e. rather than being disposed between the connecting portions 330, 332). The angle of the vane 34 corresponds to the angles of the vanes of the embodiments described with reference to FIGS. 1 to 14. The third alternative baffle component 328 is formed of a sheet, such as a plastic or metal sheet. The first and second flanges 350, 334 are unitary. The third alternative baffle component 328 may be vacuum formed.

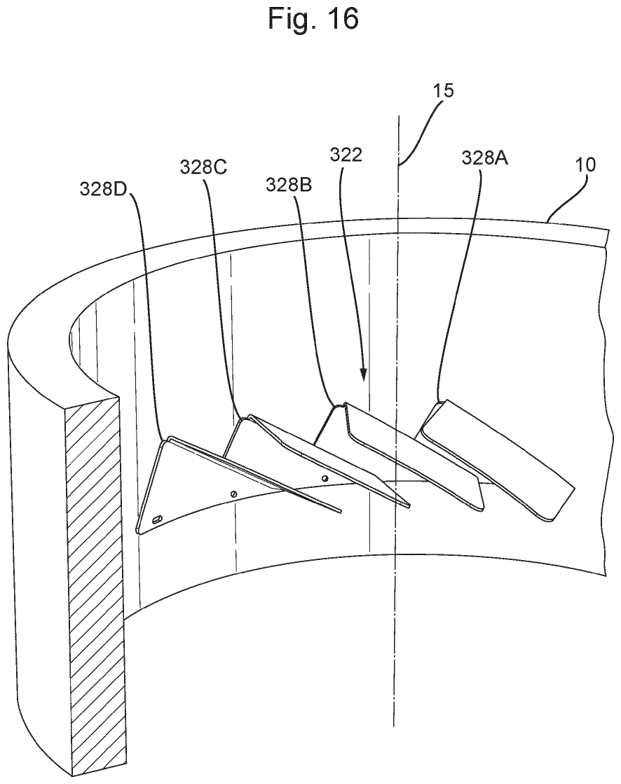

FIG. 16 is a cutaway perspective view of a baffle 322 comprising three of the third alternative baffle components 328A, 328B, 328C part way through installation. The installation process is the same as that described previously. However, since the first flange 350 defines both the first and second connecting portions 330, 332 and since the first and second connecting portions 330, 332 are not offset from each other, the first flanges 350 of adjacent baffle components 28 overlap without splicing. In alternative arrangements, the first and second connecting portions 330, 332 may be offset from each other in the manner described previously such that they splice together.

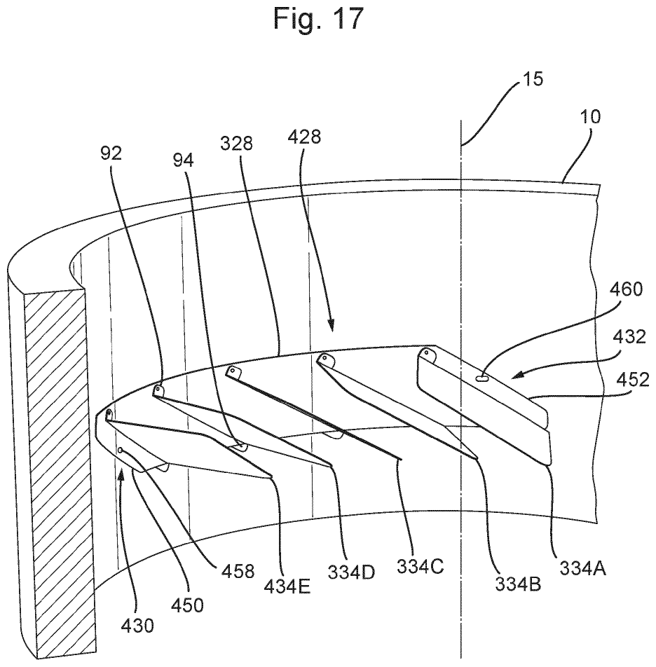

FIG. 17 is a perspective view of a fourth alternative baffle component 428. The fourth alternative baffle component 428 comprises a continuous sheet, backing or mounting strip 90 to which a plurality of vanes or inserts 434A, 434B, 434C, 434D, 434E are attached. The sheet 90 supports the vanes 434A, 434B, 434C, 434D, 434E and has sufficient flexibility to bend part way around the axis 15. Each of the vanes 434A, 434B, 434C, 434D, 434E comprises a first tab 92 and a second tab 94 for connecting the vanes 434A, 434B, 434C, 434D, 434E to the sheet 90.

A first end 450 of the sheet 90 defines the first connecting portion 430 of the fourth alternative baffle component 428. A second end 452 of the sheet 90 defines the second connecting portion 432 of the fourth alternative baffle component 428. The first connecting portion 430 comprises a hole 458. The second connecting portion 432 comprises a slot 460. The slot 460 is oriented toward the hole 458 (i.e. has its maximum dimension in a direction extending toward the hole 458). The installation process of the fourth alternative baffle component 428 is the same as that described previously.

All features described as being cylindrical may be substantially cylindrical (e.g. elliptically cylindrical). The meaning of the term cylindrical extends to such features.

Each of the baffle components of any of the arrangements described above may be identical, which reduces cost. However, this need not be the case. For example, some of the baffle components may be sized differently in order to ensure that the baffle as a whole has the correct outer diameter to fit within the chamber 10. For example, a hole and a slot of one of the baffle components may be spaced a different distance apart than a hole and a slot of another of the baffle components.

It has been described that the baffle components 28 described with reference to FIGS. 1 to 10, the first alternative baffle components 128 described with reference to FIG. 11 and the second alternative baffle components 228 described with reference to FIGS. 12 to 14 are manufactured by a rotational molding process. It has additionally been described that the third alternative baffle component 328 is vacuum formed. However, any of the baffle components may be formed by rotational molding, thermoforming or vacuum forming processes, or any other suitable process.

It has been described that the first connecting portion of each of the baffle components comprises a hole and that the second connecting portion of each of the baffle components comprises a slot, however this need not be the case. For example, in alternative arrangements, the first connecting portion of each of the baffle components may comprise a slot and the second connecting portion of each of the baffle components may comprise a hole. In further alternative arrangements, both the first and second connecting portions of each of the baffle components may comprise a slot. In yet further alternative arrangements, both the first and second connecting portions of each of the baffle components may comprise a hole.

In alternative arrangements, the features of the baffle components may be mirrored. This allows the baffle formed by the baffle components to operate in separators in which the fluid within the 24 flows in the opposing rotational direction to that described above (i.e. in separators in which the angular velocity of the flow of water in the upper region 24 of the chamber 4 is oriented toward from the lower region 26 of the chamber and away from the upper region 24 of the chamber 4).

Although it has been described that the plurality of baffle components are connected in series to each other in a continuous loop (i.e. so as to form an unbroken series or chain of connected baffle components), this need not be the case. For example, two adjacent baffle components of the plurality of baffle components may not be connected together such that they form beginning and end baffle components of an otherwise unbroken chain of baffle components that extend part way around the axis.

Although it has been described that the first and second flanges are substantially triangular in shape, this need not be the case. For example, one or both of the first and second flanges may be substantially rectangular and extend along the length of the first and second support structures (i.e. between an upper and lower end of the baffle component). In alternative arrangements, one or both of the first and second flanges may be directly connected to the vane and the first and second support structures may be omitted.

1. A baffle for a separator having a cylindrical chamber, the baffle comprising a plurality of baffle components arranged in series at least part way around an axis, wherein each of the plurality of baffle components comprises a first connecting portion and a second connecting portion, wherein the first connecting portion of each of the plurality of baffle components is connectable to the first or second connecting portion of a respective first adjacent baffle component of the plurality of baffle components, wherein the second connecting portion of each of the plurality of baffle components is connectable to the first or second connecting portion of a respective second adjacent baffle component of the plurality of baffle components, wherein at least one of the baffle components comprises a vane angled with respect to the axis so as to impede the passage of fluid past the baffle.

2. A baffle as claimed in claim 1, wherein the plurality of baffle components are connected in series in a continuous loop that extends around the axis.

3. A baffle as claimed in claim 1, wherein each of the plurality of baffle components comprises a first flange defining the first connecting portion and a second flange defining the second connecting portion.

4. A baffle as claimed in claim 3, wherein the first flange is connected to the vane by a first support structure, wherein the second flange is connected to the vane by a second support structure, wherein the first flange is recessed with respect to the first support structure and wherein the second flange extends beyond the second support structure in a direction perpendicular to the angle of the vane.

5. A baffle as claimed in claim 4, wherein at least a portion of the profile of an edge of the first flange corresponds to at least a portion of the profile of an edge of the second flange.

6. A baffle as claimed in claim 3, wherein the first and second flanges are offset from each other in a dimension perpendicular to the axis.

7. A baffle as claimed in claim 3, wherein the first and second flanges curve toward the vane in a distal direction.

8. A baffle as claimed claim 1, wherein the first connecting portion and the second connecting portion of two or more of the plurality of baffle components are configured to allow the extent to which the two or more of plurality of baffle components overlap each other to be adjusted during installation of the baffle within the cylindrical chamber.

9. A baffle as claimed in claim 1, wherein one of the first or second connecting portions of at least one of the plurality of baffle components comprises a hole (58) for connecting the baffle component to a first adjacent baffle component and the other of the first or second connecting portions of the baffle component comprises a slot for connecting the baffle component to a second adjacent baffle component, wherein the slot is oriented toward the hole.

10. A baffle as claimed claim 1, wherein each of the plurality of baffle components comprises a respective vane angled with respect to the axis so as to impede the passage of fluid past the baffle.

11. A baffle as claimed claim 1, wherein the vane of each of the plurality of baffle components comprises a leading edge surface, wherein the leading edge surfaces of each of the vanes are coplanar and form part of an interrupted annular surface extending perpendicularly to the axis.

12. A baffle as claimed in claim 1, wherein each of the vanes defines a channel extending through the respective baffle component.

13. A baffle as claimed in claim 1, wherein the vane of each of the baffle components is disposed between the first and second connecting portions of the respective baffle component

14. A baffle as claimed in claim 1, wherein one or more of the baffle components comprises a plurality of vanes separated by one or more gaps.

15. A baffle as claimed in claim 1, wherein each vane defines a recess having an interior profile corresponding to an exterior profile of the vane.

16. A baffle as claimed in claim 1, wherein the vanes overlap in a circumferential direction of the baffle such that they extend circumferentially around the entirety of the baffle.

17. A baffle as claimed in claim 1, wherein the vanes are cantilevered.

18. A baffle as claimed in claim 1, wherein the vanes are supported at their radially outer end.

19. A baffle as claimed in claim 1, wherein the baffle components are substantially identical.

20. A baffle as claimed in claim 1, wherein the baffle components are formed by a molding process.

21. A baffle component as described in claim 1.

22. A separator as described in claim 1, wherein the cylindrical chamber comprises an upper region and a lower region, wherein the upper region comprises an inlet module configured to deliver flow into the cylindrical chamber in a rotational direction about the axis, wherein the baffle is disposed between the upper region and the lower region and impedes the passage of fluid past the baffle from the upper region to the lower region, wherein the vanes are angled toward the upper region in the rotational direction.

23. A method for assembling a baffle as claimed in claim 1, the method comprising:
positioning the plurality of baffle components within the cylindrical chamber; and
connecting the first connecting portion of each of the plurality of baffle components to the second connecting portion of a respective adjacent baffle component of the plurality of baffle components and to the cylindrical chamber.
